(19) United States
(12) Patent Application Publication
(10) Pub. No.: US 2005/0001085 A1
(43) Pub. Date: Jan. 6, 2005

(54) Spool for fishing line

(76) Inventor: Fujita Kimura, Kobe-shi (JP)

Correspondence Address: DUANE MORRIS, LLP;IP DEPARTMENT, ONE LIBERTY PLACE, PHILADELPHIA, PA, 19103-7396, US

(21) Appl. No.: 10/865,370

(22) Filed: Jun. 10, 2004

(30) Foreign Application Priority Data
Jun. 11, 2003 (JP) 2003-197458

(51) Int. Cl. A01K 89/01

(52) U.S. Cl. 242/227

(57) ABSTRACT

A spool (10) for fishing line according to the present invention has a main body (11) including a first flange (14) and a hollow cylindrical portion (13) formed integral with each other, and a second flange (12), all formed of resin or metal. The second flange (12) is snugly fitted into the bore in the cylindrical portion (13). The cylindrical portion (13) can be tapered to have a frustoconical shape. Through-holes (15, 20) are formed in the first and second flanges (14, 12). Also, cuttings (17, 23) are formed in the outer peripheries of the first and second flanges (14, 20).

This invention relates to a structure of a spool for a long fishing line.

### BACKGROUND OF THE INVENTION

Usually, when a fishing line is sold, it is cut to a predetermined length of, for example, from 50 m to 150 m and wound around a spool. Usually, winding of fishing line around spools is carried out automatically by means of a line winding machine. A conventional fishing line spool is usually in the form of a bobbin, which includes a cylindrical portion around which a fishing line is wound, and flanges disposed at opposite ends of the cylindrical portion. See, for example, Japanese Patent Application Publication Nos. HEI 11-220990 A, 2000-157134 A, 2000-37155 A, and 2002-101798 A.

Since conventional fishing line spools are driven to rotate by a winding machine, they are provided with sufficiently large rigidity. Such spools are usually formed of resin, and, in order to provide them with large rigidity, the cylindrical portion and the flanges are formed thick. Furthermore, multiple ribs are formed to interconnect the cylindrical portion and the flanges, which provides the spools with a complicated shape. From the viewpoint of strength, “overquality” is seen in conventional fish line spools.

Recently, fishing lines having a length (e.g. 600 m), which is longer than the length of conventional lines, have been sold, being simply coiled and packaged, without being wound around spools. (Hereinafter, such simply coiled line, not wound on spools, is referred to a coiled fishing line or coil of fishing line.) How to keep such coiled fishing lines is left to anglers. In order for anglers to keep such coiled lines safe, preventing tangling of the lines, it will be advantageous for them to use fishing line spools as holders for keeping the coiled fishing lines.

An object of the present invention is to provide a fishing line spool which has a very simple structure with rigidity necessary and sufficient for the spool to be driven to rotate by a fishing line winding machine for winding a fishing line around it, and can be used also as a coiled line keeping holder.

### SUMMAY OF THE INVENTION

A spool for a fishing line according to the present invention has a main body. The main body includes a hollow, cylindrical portion. The thickness of a wall of the cylindrical portion is from 0.8 mm to 2.7 mm. The main body includes a first flange at one end of the cylindrical portion. The first flange is formed integral with the cylindrical portion, and has a thickness of from 1.0 mm to 2.7 mm. A second flange is detachably attached to the other end of the cylindrical portion to oppose the first flange. The second, detachable flange has a thickness of from 1.2 mm to 2.4 mm. The main body including the cylindrical portion and the first flange, and the second, detachable flange are formed of resin or metal. Center through-holes, which are concentric with each other, are formed in the first and second flanges, through which a drive shaft of a fishing line winding machine is adapted to be inserted.

With the above-described structure of a fishing line spool, the amount of resin or metal necessary for manufacturing the spool can be smaller. Also, the described structure can eliminate the use of other members, such as ribs, which are used in conventional spools. Thus, the spool of the above-described arrangement can be simpler in structure.

By virtue of the above-described thicknesses of the cylindrical portion, the first flange and the second flange, the fishing line spool of the present invention can have rigidity or strength sufficient for the spool to be driven by a fishing line winding machine to properly wind a fishing line around it. During the winding operation, the winding shaft of the winding machine is inserted into the shaft holes formed in the first and second flanges.

Since the second flange is detachably mounted to the main body, the spool can be used as a holder for a coiled fishing line. More specifically, first, the second flange is detached from the cylindrical portion, and, then, the cylindrical portion is inserted into the opening in the coil of the fishing line, so that the coiled line can be supported by the main body. After that, the second flange is attached to the main body again, and the coiled fishing line is securely held by the spool.

The cylindrical portion is desirably tapered such that it has a diameter gradually increasing from the second flange side toward the first flange side. The tapered cylindrical portion enables smooth insertion of the cylindrical portion into the opening in the coil of fishing line.

The second flange may desirably have a cylindrical portion adapted to be snugly fitted into an axially extending bore of the cylindrical portion of the main body, and a plate member formed integral with the outer end surface of the cylindrical portion. With this arrangement, the second flange can be easily attached to the main body by simply fitting the cylindrical portion thereof into the cylindrical portion of the main body, and can be easily separated by simply disengaging the cylindrical portion thereof from the cylindrical portion of the main body.

The second flange may include a cylindrical portion adapted to be screwed into the axial bore of the cylindrical portion of the main body, and a plate member formed integral with the outer end surface of the cylindrical portion. With this arrangement, the second flange can be securely attached to the main body by simply screwing the second flange in an appropriate direction, and easily separated by unscrewing in the opposite direction.

The diameter of the second flange is preferably from 90% to 95% of the diameter of the first flange. With this arrangement, even when the spool rolls on the ground by chance, it will tilt toward the second flange side and falls down sideways. The spool cannot continue to roll much, but falls down sideways immediately, so that it can hardly be lost in, for example, a fishing spot.

The second flange is preferably provided with a plurality of through-holes having a diameter of from 4.0 mm to 12.0 mm. Providing such holes in the second flange can further reduce the weight of the spool. Because of the described structure and dimensions of the main body and the second flange, the required rigidity of the spool can be secured despite the provision of the through-holes. Also, the through-holes can provide holds for the second flange. For example, an angler can put his fingers in the through-holes when handling the second flange to attach or separate it to and from the main body, which makes attachment and separation of the second flange easier.

The first and second flanges are preferably provided with a cutting in their outer peripheries. With this arrangement, when a fishing line is to be wound around a plurality of spools arranged side by side, the line can override flanges of adjacent spools at the cuttings in the respective flanges and be caught by edges of the cuttings, so that the fishing line can be wound smoothly around a plurality of spools. The cuttings are also advantageous because they can let the spools fall down sideways easily.

### BRIEF DESCRIPTION OF THE DRAWINGS

FIG. 1 is a perspective view of a fishing line spool according to one embodiment of the present invention.

FIG. 2 is an exploded, perspective view of the spool shown in FIG. 1.

FIG. 3 is an exploded, cross-sectional view along the line III-III in FIG. 1.

FIG. 4 is an exploded, cross-sectional view of a modification of the spool shown in FIG. 1, similar to FIG. 3.

### DETAILED DESCRIPTION OF THE EMBODIMENT

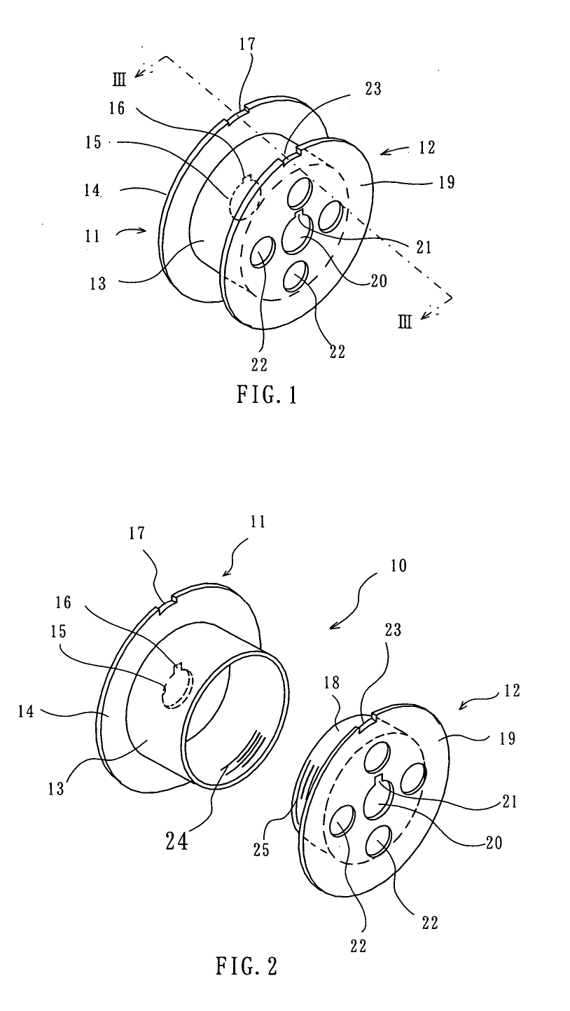

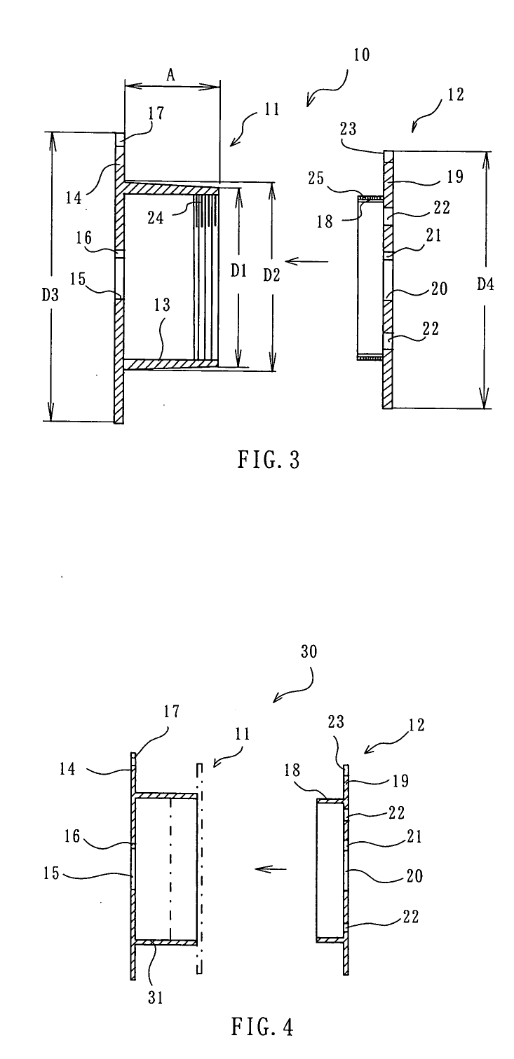

As shown in FIG. 1, a fishing line spool 10 according to the present invention has a main body 11 including a hollow cylindrical portion 13 and a first flange 14, and a second flange 12. The cylindrical portion 13 and the first flange 14 are integrally formed of, for example, synthetic resin or metal. The cylindrical portion 13 is tapered into a frustoconical shape. Thus, the cylindrical portion 13 is referred to hereinafter as frustoconical portion. For example, as shown in FIG. 3, the outer diameter D1 of the frustoconical portion 13 at its distal end, which is remote from the first flange 14 and faces the second flange 12, is 52.5 mm, and the outer diameter D2 at the proximal end, at which the frustoconical portion 13 joins in the first flange 14, is 53.0 mm. It should be noted that these values of the outer diameters of the frustoconical portion 13 are not limiting, but they can be changed depending on a thickness of a fishing line to be wound around the frustoconical portion 13 if the slope of tapering is from 1/90 to 5/90.

The thickness of the wall of the frustoconical portion 13 is from 0.8 mm to 2.7 mm. The thickness of the wall of the frustoconical portion 13 referred to herein is the thickness at the distal end and, therefore, the smallest thickness of the wall of the frustoconical portion 13. Preferably, the thickness of the wall of the frustoconical portion 13 is from 0.8 mm to 2.2 mm, and more preferably, it is from 1.0 mm to 2.0 mm.

The length A in the axial direction of the frustoconical portion 13 is within a range of from 4.5 mm to 90 mm. The length A is determined in accordance with the thickness and length of the line to be wound around it.

The inner surface of the distal end portion of the frustoconical portion 13 is provided with a thread 24, with which a thread 25 formed on the second flange 12 is adapted to be engaged for attaching the second flange 12 to the frustoconical portion 13.

The first flange 14 is disc-shaped and has its one major surface joined integral with the proximal end of the frustoconical portion 13. The first flange 14 is concentric with the frustoconical portion 13. The diameter D3 of the first flange 14 is from 50 mm to 100 mm, and has a thickness of from 1.0 mm to 2.7 mm, preferably from 1.0 mm to 2.2 mm, and more preferably from 1.0 mm to 2.0 mm.

A cutting or recess 17 is formed in the periphery of the first flange 14.

A shaft hole 15 with a keyway 16 (hereinafter sometimes referred to simply as shaft hole) is formed through the center portion of the first flange 14. The shaft hole 15 is concentric with the frustoconical portion 13. When the spool 10 is engaged with a fishing line winding machine (not shown), a driving shaft of the winding machine is inserted into the shaft hole 15. The keyway 16 is for receiving a key on the driving shaft of the winding machine, so that the spool 10 can be secured in place on the winding machine driving shaft.

The second flange 12 is detachably mounted to the distal end portion of the frustoconical portion 13 to face the first flange 14. This provides the frustoconical portion 13 with two flanges at its opposite ends.

In the illustrated example, the second flange 12 is formed of a cylindrical portion 18 and a disc-shaped plate 19 formed integral with the cylindrical portion 18. The cylindrical portion 18 and the disc-shaped plate 19 are formed of, for example, synthetic resin or metal. The outer diameter of the cylindrical portion 18 is from 1.2 mm to 2.4 mm, preferably from 1.2 mm to 2.2 mm, and more preferably from 1.2 mm to 2.0 mm.

The outer surface of the cylindrical portion 18 is provided with the threaded 25. The cylindrical portion 18 with the thread 25 is screwed into the interior of the frustoconical portion 13 provided with the corresponding thread 24.

The disc 19 has an outer diameter D4 of from 45 mm to 99 mm, which is smaller than the diameter D3 of the first flange 14. There is a relationship between D3 and D4, which can be expressed as D3×0.9<D4<D3×0.95. The disc 19 has a thickness of from 1.2 mm to 2.4 mm, preferably of from 1.2 mm to 2.2 mm, and more preferably of from 1.2 mm to 2.0 mm. In addition, the disc 19 is provided with a cutting 23 in its periphery. The cutting 23 is similar to the cutting 17 in the first flange 14.

A shaft hole 20 with a keyway 21 (hereinafter sometimes referred to simply as shaft hole) is formed through the center portion of the disc 19. The shaft hole 20 is concentric with the frustoconical portion 13. When the spool 10 is engaged with the fishing line winding machine, the driving shaft of the winding machine is inserted into the shaft hole 20. The keyway 21 is for receiving the key on the driving shaft of the winding machine, so that the spool 10 can be secured in place on the winding machine driving shaft.

The disc 19 is provided with a plurality of through-holes 22 having a diameter of from 4.0 mm to 12.0 mm. In the illustrated example, four holes 22 are formed. The number of the through-holes 22 is not limited to four, but a suitable number can be selected.

The fishing line spool 10 shown in FIGS. 1 through 3 is assembled by screwing the cylindrical portion 18 of the second flange 12 into the frustoconical portion 13 of the spool main body 11. With the above-described dimensions and structure, the amount of resin or metal for forming the spool 10 can be smaller than required in conventional spools. Also, since no additional components, such as ribs, need be required, the structure of the spool 10 is very simple. Furthermore, because of the dimensions and structure of the first and second flanges 14 and 12 and the frustoconical portion 13, the spool 10 can have sufficient rigidity, which allows satisfactory winding of a fishing line around it with a winding machine having its driving shaft inserted through the shaft holes 15 and 20 in the first and second flanges 14 and 12.

When a fishing line on the spool 10 is used out, leaving no line on it, the spool 10 can be used as a holder to hold and keep a coil of fishing line. Specifically, the detachable second flange 12 is separated from the main body 11, and the frustoconical portion 13 of the main body 10 is inserted into the center opening in the coil of line. Then, the second flange 12 is attached to the frustoconical portion 13 again. In this manner, the coil of fishing line can be held on the frustoconical portion 13 on the spool 10.

As described above, the spool 10 for fishing line according to the present invention can be made of a small amount of resin or metal, can be light in weight and still sufficiently rigid, and can be used as a holder for holding a coiled fishing line. This feature enables a fishing line spool, which, when a line around it has been used out, would be thrown away as trash, to be used again. This reduces the amount of trash dumped as well as waste of resources.

By forming a plurality of through-holes 22 in the second flange 12, the spool 10 can be further reduced in weight. The holes 22 also enables an angler to insert his or her fingers in them when rotating the second flange 12 to mount or separate it to or from the main body 11, so that he or she can attach or separate the second flange 12 to and from the main body 11 with ease.

Because of the above-described diameters and thicknesses of the main body 11 and the second flange 12, the rigidity required for a fishing line spool can be secured even when the second flange 12 is provided with the through-holes 22. Similar through-holes may be formed in the first flange 14, which may further reduce the weight of the spool 10. It should be noted that no through-holes could be formed in either flange.

Because of the tapering of the frustoconical portion 13 of the main body 11, the frustoconical portion 13 can be smoothly, easily and quickly inserted into the center opening of a coiled fishing line when the spool 10 is to be used as a holder for the coiled fishing line.

According to the described embodiment, the second flange 12 can be easily and readily fixed to the main body 11 by simply screwing the cylindrical portion 18 of the second flange 12 into the frustoconical portion 13 of the main body 11. Thus, the assembling and disassembling of the spool 10 can be done quickly, which facilitates the use of the spool 10 as a holder for a coil of fishing line.

Instead of attaching the second flange 12 to the main body 11 by screwing, any other means may be adopted for attaching. For example, the cylindrical portion 18 of the second flange 12 may be simply fitted into the bore of the frustoconical portion 13 of the main body 11. In such case, the outer diameter of the cylindrical portion 18 of the second flange 12 and the diameter of the bore in the frustoconical portion 13 of the main body 11 are determined so as to enable snug fitting of the two cylindrical portions 13 and 18. This arrangement may realize easy and secure attachment and separation of the second flange 12 to and from the main body 11.

Since the diameter D4 of the second flange 12 is smaller than the diameter D3 of the first flange 14, the spool 10 will fall down sideways as soon as it is dropped on the ground, and, therefore, the possibility of the spool 10 being lost due to rolling away of the spool 10 can be reduced.

The cuttings 17 and 23 formed in the outer peripheries of the first and second flanges 14 and 12 facilitate smooth winding of a fishing line around a plurality of spools 10 arranged side by side which are rotated together for continuously winding the line around them, because the fishing line can extend over the respective cuttings 17 and 23 from one spool to an adjacent one and be caught by an edge of the cuttings 17 and 23 when it overrides the cuttings 17 and 23. These cuttings 17 and 23 also help the spool 10 to fall down sideways quickly.

A modification 30 of the spool 10 is shown in FIG. 4. The only difference of the spool 30 shown in FIG. 4 from the spool 4 shown in FIGS. 1-3 is the shape of a cylindrical portion 31 of the main body 11. The cylindrical or frustoconical portion 13 shown in and described with reference to FIGS. 1 through 3 is tapered from the first flange side toward the second flange side, whereas the cylindrical portion 31 of the modified spool 30 is not provided with such taper, but has the same diameter over its entire length from the first flange side to the second flange side. Because the portion 31 of the spool 30 around which a fishing line is to be wound is a true cylinder, the turns of line wound on the cylindrical portion 31 regularly arranged. Furthermore, because the cylindrical portion 31 is a simple cylinder, the spool 30 can have a simpler structure and, therefore, can be manufactured at a lower cost.

The first and second flanges 14 and 12 have been described to have a circular disc-shape, but they may be polygonal, for example, square or hexagonal in shape.

1. A spool for fishing line, comprising:
a main body including a hollow, cylindrical portion defined by a wall having a thickness of from 0.8 mm to 2.7 mm, and a first flange formed integral with one end of said cylindrical portion, said first flange having a thickness of from 1.0 mm to 2.7 mm; and
a second flange detachably attached to the other end of said cylindrical portion to oppose said first flange, said second flange having a thickness of from 1.2 mm to 2.4 mm;
said main body and said second flange being formed of resin or metal;
said first and second flanges being provided with concentric shaft holes at the centers thereof, through which a spool driving shaft of a line winding machine is adapted to be inserted.

2. The spool according to claim 1 wherein said cylindrical portion has an outer shape tapering from said one end toward said other end.

3. The spool according to claim 1 wherein said second flange comprises a cylindrical portion to be fitted into an axially extending bore in said cylindrical portion of said main body, and a plate formed integral with said cylindrical portion.

4. The spool according to claim 1 wherein said second flange comprises a cylindrical portion to be screwed into an axially extending bore in said cylindrical portion of said main body, and a plate formed integral with said cylindrical portion.

5. The spool according to claim 1 wherein said second flange has an outer diameter of from 90% to 95% of an outer diameter of said first flange.

6. The spool according to claim 1 wherein said second flange is provided with a plurality of through-holes having a diameter of from 4.0 mm to 12.0 mm.

7. The spool according to claim 1 wherein a cutting is formed in an outer periphery of each of said first and second flanges.
